(19) United States
(12) Patent Application Publication
(10) Pub. No.: US 2007/0144639 A1
(43) Pub. Date: Jun. 28, 2007

(54) Monitoring system of the inner state of tires and a method for operating the system

(76) Inventor: Mi-Kyung Oh, Seoul (KR)

Correspondence Address: DILWORTH & BARRESE, LLP, 333 EARLE OVINGTON BLVD., SUITE 702, UNIONDALE, NY, 11553, US

(21) Appl. No.: 10/546,852

(22) PCT Filed: Feb. 27, 2004
(86) PCT No.: PCT/KR04/00430

§ 371 Date: Nov. 27, 2006

(30) Foreign Application Priority Data
Feb. 27, 2003 (KR) 10-2003-0012363
Mar. 21, 2003 (KR) 10-2003-0017676
Apr. 1, 2003 (KR) 10-2003-0020640

(51) Int. Cl. B60C 19/08; B60C 23/02

(52) U.S. Cl. 152/152.1; 340/442

(57) ABSTRACT

A casing device for installing a TPMS wireless transmitter in a wheel of an automobile's tire has a lower case and an upper case, wherein the lower case adheres to the outer surface of the wheel and has the same curved surface as the wheel and the upper case includes the wireless transmitter in itself and combines with the lower case and adheres to it. And in a method for transmitting wireless data a transmitter checks predetermined data transmitting conditions before transmitting wireless data to a receiver and transmits data by using TDMA method if the data transmitting condition is satisfied, or else by using CDMA method.

### BACKGROUND OF THE INVENTION

This invention relates to a tire pressure monitoring system (TPMS) of an automobile. More specifically speaking, this invention relates to a TPMS, a method for operating a TPMS and a transmitter's casing device of the system, and discloses a technology monitoring a tire's inner state by using a hybrid digital RF data transmission method combining only the benefits of CDMA (Code Division Multiple Access) and TDMA (Time Division Multiple Access). Repeatedly speaking, this invention uses a CDMA Multiple Access technology (Multiple Access: a technology making simultaneous multi-channel communication possible by changing codes into channels respectively at the same frequency bandwidth), and Binary CDMA technology is used in order to prevent from the defects of prior CDMA method (DS-CDMA: Direct Sequence-Code Division Multiple Access), which cause system complexity and increase production cost depending upon the increase of signals' multiple levels according to the number of channels. From the Binary CDMA technologies so far invented, this invention uses the technology of CS (Code Select)-CDMA and CAC (Constant Amplitude Coding)-CDMA.

### PRIOR ART OF THE INVENTION

While a car is in motion, sudden decrease of tire pressure may cause a large-scaled traffic accident. Namely, because of high-speed motion of a car under the condition of low tire pressure spreading and narrowing of surface of a tire's side part is repeated and the tire cannot overcome its fatigue and is flattened and the car cannot be driven any more. In addition a tire may burst or be separated from a car and the car may overturned. Accordingly a tire pressure monitoring system was introduced to prevent from such an accident.

In U.S.A. from October 2006 every automobile should mount a TPMS in itself and accordingly it is expected that in other countries too every automobile should mount a TPMS in itself.

Roughly speaking, there are two kinds of TPMS, a direct-type TPMS and an indirect-type TPMS. The direct-type TPMS functions as that an electronic sensor, which is installed to each tire wheel, monitors the inner pressure and temperature of a tire and lets a driver know it through wireless means, and the indirect-type TPMS uses characteristics that the rotation number of a tire becomes different if the tire pressure becomes different each other. But the direct-type TPMS has better performance than the indirect-type TPMS.

On the other hand, once a transmitter's casing device of a prior TPMS of an automobile is mounted, it cannot be mounted again or it is difficult to adhere and separate it and it is impossible to recycle it and also its size is large and its structure is complicated and its manufacturing cost is high to influence to the production cost. Also there was a problem that the existing tire wheel structure has to be changed.

Therefore to avoid the above problems a transmitter's casing device, which can be mounted again repeatedly several times and adhered and separated easily and has low cost and simple structure having advantages in the later management, is needed.

Generally, in case of transmission of the inner state data of tires of an automobile from a transmitter attached to each tire to a receiver by using an RF data transmission method, if each transmitter transmits data with identical electric power and each tire is too close to restore the data, then the data are destroyed. Also, it is impossible to completely protect of the transmitted data by an external interference noise.

But, the above data can be restored if a CDMA (Code Division Multiple Access) technology using a spread spectrum technique is adopted. The reason is the CDMA technology has strong characteristics against an external noise, an interference signal and a multi-path and has definitely distinguishable characteristics among channels. A DS-CDMA (Direct Sequence CDMA), a PW-CDMA (Pulse Width CDMA) and a CS-CDMA (Code select CDMA) are included in this category.

In the DS-CDMA technology, because channel's signals are simultaneously added and transmitted, as the number of channels increases, the number of levels for the output signal increases to be a multi-level and then has a form of an analog signal having various leveled values like a video signal. Therefore, an expensive linear amplifier having a wide dynamic range should be used in the RF amplifier and the signal processing at the receiving part becomes complicated. As a result, the electric power efficiency is lowered and the lifetime of the battery will be badly affected, and difficulty for embodying the system will be increased as the degree of complexity for the signals generating at the multi-channel will be increased and the system price will be high. Therefore, as the system structure by this technology is complex and the price is high, this technology is not fit to the technology for the monitoring system of the inner state of a tire.

On the other hand, in the PW-CDMA technology, as the spectrum range of modulating signals is not increased continuously with increasing of the number of the channel, it is possible to use a usual digital power amplifier without a linear high frequency output amplifier. So, it is possible to make the power efficiency high and the system structure simple and the system price low. But, in case of using this technology to a system for monitoring of inner state of a tire, the data from external interference are protected and can be transmitted safely only by increasing processing gain (e.g. up to 1024 chips) and expanding it.

Generally, the efficiency of a CDMA system using a spreading spectrum communication technique depends on a processing gain. The expression ‘a system has a good efficiency’ means that it has strong characteristics against every surrounding noise signal interference and disturbing signal (Jammer) and maintains low error probability. At this time, the processing gain or the spreading ratio means the extent of spectrum spreading and also this means a ratio of a chip rate to bit rate or a ratio of time interval between bits to time interval between chips. Therefore, the time interval between chips should be reduced in order to increase the processing gain.

And to spread data to 64 chips means to change 16 bits to 64 bits for transmission in case of 16 bits transmission. Therefore, using 1024 chips instead of 64 chips means that bits should be 1024 bits in case of 16 bits transmission. And increasing the number of chips means that the number of data bit to be transmitted should be increased. For example, suppose that total transmitting amount at present to be transmitted is 648 bits in case of spreading with 64 chips, if the spreading is executed by 128 or 1024 chips, the total transmitting amount to be transmitted is changed respectively to 840 bits and 4424 bits.

On the other hand, when the specification of a monitoring system for monitoring inner state of a tire is that the battery capacity and the power consumption of a transmitter is 560 mA and 20 mA respectively, and if people want to use the transmitter for 5 years, the data transmitting interval in accordance with the number of the spreading chips is as follows. That is, if the number of the spreading chips is 64 chips, 128 chips and 1024 chips, then the data-transmitting interval is 101 seconds (about 1.7 minutes), 131 seconds (about 2.2 minutes) and 691 seconds (about 11.5 minutes) respectively.

Therefore, if we assume that the monitoring system for inner state of a tire is applied to an automobile, it is hard to guarantee the stability of data sent from 4 tires with 64 spreading bits. In order to guarantee the stability, it is necessary to increase the spreading bits but, in that case, a problem to increase transmitting interval is generated. As a result, if the number of spreading chips increases and the transmitting interval increases, then the consumption amount of battery increases and the lifetime decreases. And in the PW-CDMA technique, there is a strong point to make the system to simple by cutting the DS-CDMA type signal levels having level size over a predetermined value and by protecting increment of the signal level. But this PW-CDMA type like the DS-CDMA type assigns each information channel to each orthogonal code and then use the same number of orthogonal codes to the number of information channels. So if the number of channels increases, then there are problems to increase the number of the orthogonal codes and to increase the instant amplitude change of the modulated transmitting signals and to make multi-level. And in level clipping process for the multi-level signals, there are weak points that the degree of orthogonal of the orthogonal codes is damaged and becomes weak by interference between transmitting signals. Therefore, if the PW-CDMA technology is applied to a monitoring system for inner state of tires, the lifetime of the system cannot be guaranteed and the system can be weak by interference between transmitting signals.

As another digital transmitting technology, the TDMA type has been adopted as a standard in U.S.A. and 30 KHz is assigned to each channel and 3 TDMA slots are assigned also to each use and so each user can own the overall frequency band commonly. But in this way, the capacity can increase 3 times compared to an analog system, but it is only ⅙ of the CDMA capacity. And even though increasing the rate of frequency reusing by weakening the degree of isolation between cells, the TDMA capacity is less than 30% of the CDMA capacity. And the Erlang capacity for the TDMA type is only ⅕ of the CDMA type. But this type has a strong point to transmit data simply and stably.

### BRIEF DESCRIPTION OF THE DRAWINGS

FIG. 1 is showing arrangement of a monitoring system according to the present invention in an automobile.

FIG. 2 is showing automobile states based on various state levels according to the present invention.

FIG. 3 is an exterior view of an instrument for inputting and receiving information for tire identification according to the present invention.

FIG. 4 is a structural view of the transmitting data frame according to the present invention.

FIG. 5 is an embodiment of internal structure of a transmitter of the system of FIG. 1.

FIG. 6 is an embodiment of internal structure of a receiver of the system of FIG. 1.

FIG. 7 is a diagram showing an operating method in the system according to FIG. 1.

FIG. 8 is showing state levels of a tire in motion and a reserved tire.

FIG. 9 is a timing chart showing that the transmitting data are loaded on carrier wave and modulated by a TDMA RF method according to the present invention.

FIG. 10 is a structural view of 16 bits window frame used as an embodiment in the present invention.

FIG. 11 is a structural view of transmission frame under normal pressure condition according to the present invention.

FIG. 12 is an embodiment of a CDMA modulator frame according to the present invention.

FIG. 13 is a diagram showing a transmitter case of a TPMS of an automobile installed inside of a tire according to the present invention.

FIG. 14 is a bottom view of a transmitter case of a TPMS of an automobile installed inside of a tire according to the present invention.

FIG. 15 is a structural view of a transmitter case of a TPMS of an automobile according to the present invention.

This invention can be modified into variously forms. Although only specific embodiments are shown in the detail description of this invention, this invention should be understood not to be confined to the following embodiments and but rather to include all the modifications and replacements within the scopes and sprits of this invention defined by the claims.

### DETAILED DESCRIPTION OF THE INVENTION

1. A Transmitter Casing Device for a Tire Pressure Monitoring System

### 1. A 1st Preferred Embodiment

This invention is a group of method related to a direct-type Tire Pressure Monitoring System (TPMS) of an automobile, wherein the method includes a casing device for installation of a wireless transmitter of this system into tire wheel. A casing device of the invention has a lower case and an upper case, wherein the lower case adheres to the outer surface of the wheel by a great strong both-sided adhesive agent and has the same curved surface as the wheel and the upper case includes a wireless transmitter in itself and combines with the lower case and adheres to it.

And the above lower case (20) comprises a thermal-transit path (18) transmitting inner heat of an upper case (12) to the surface of a wheel rapidly, a pair of female-concaves (17, 19) which are space having a trapezoid-shape section placed in either side of said thermal-transit paths respectively, a female-rack (22) placed in another side of said thermal-transit paths, a combining groove (23) which has a predetermined size and depth, formed in predetermined place of said female-rack (22), a contact portion (21) which has predetermined radius of curvature for the female-rack's easy bending when force is applied to the female-rack in the upper direction, and is placed in connecting part between said female-rack (22) and lower case (20).

Said upper case (12) comprises a male-rack (13) placed on an upper case (12) surface and having a risen part of “ [symbol] ” shape toward the surface a pair of male-prominences (14, 15) placed in both of left and right sides of the lower part of upper case and having a section of trapezoid shape and a size corresponding to ones of said female-concaves (17, 19) and a space formed between said male-prominences (14, 15) and functioning as entrance for inserting a wireless transmitter (11) to an upper case (12).

It is characterized in that said female-concaves' (17, 19) section has trapezoid-shape, and one side of the female-concaves has open state and the other side has close state in order to prevent male-prominences adhered firmly to said upper case (12) from separating and the upper face of said female-concaves (17, 19) has open state and the lower face has close state.

In order to assemble the upper case (12) including wireless transmission device therein into the lower case (20), the male-prominences (14, 15) of said upper case (12) is settled to adjust the entrance of female-concaves (17, 19) of said lower case (20) and then said male-prominences (14, 15) according to guidance of the groove of the female-concaves is pushed in the direction from front-open side of said female-concaves (17, 19) to the opposite-closed side of it to insert firmly and then the female-rack (22) is bent toward the upper direction until that said combining groove (23) is caught by said male-rack (13). When we wish to separate said upper case (12) from the lower case (20), it is characterized in that we give force to the female-rack (22) in order to get out the combining groove (23) from the male-rack (13) and then push in the forward direction from rear side and separate the upper case (12).

It is characterized in that the upper and lower case (12, 20) made of plastic, which has low thermal conductivity, not to transmit the tire's inner heat to a wireless transmitter (11) placed in said upper case (12)

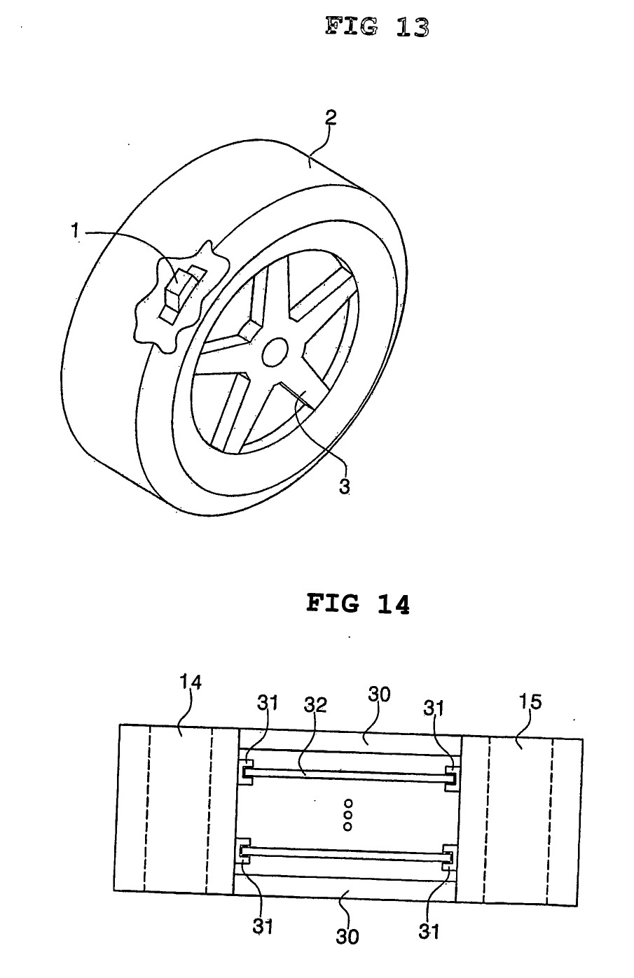

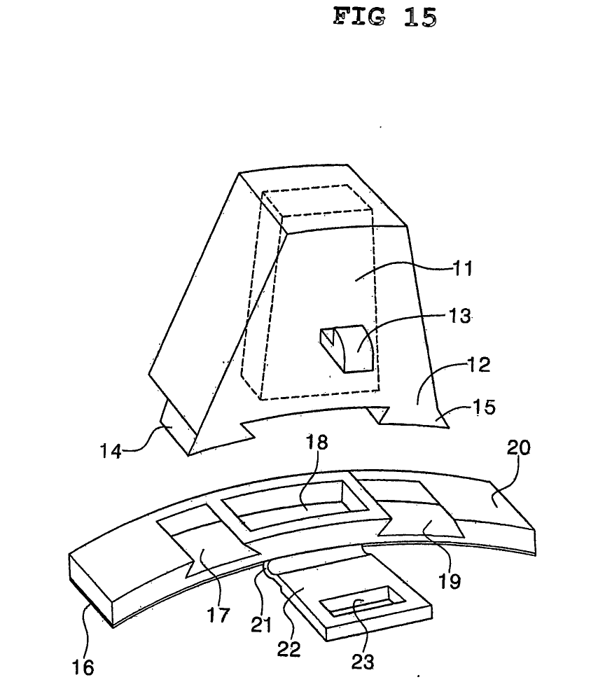

This invention can be applied for a direct type TPMS. FIG. 13 is illustrating a transmitter case for a tire pressure monitoring system of an automobile according to the present invention installed inside of a tire. FIG. 14 shows a structure of a transmitter-casing device for a tire pressure monitoring system of an automobile according to the present invention. FIG. 15 is a bottom diagram of a transmitter casing device for a tire pressure monitoring system of an automobile according to the present invention installed inside of a tire.

30 is a side part of an upper case and 31 is a PCB guide, which guides PCB (32) for a wireless transmitter (11). In this case, it has two PCBs (32). That is, by pushing and inserting the PCB (32) for the wireless transmitter (11) into said guide (31) from the bottom face of the upper case (12), said PCB (32) is adhered to said guide (31) firmly.

The lower case (20) adheres to the inner surface of the wheel (3) by a super-hard, both-sided adhesive agent (16) like the FIG. 14 and the wireless transmitter (11) being inside of a TPMS is combined under the condition taken in the upper case (12) (shown in dotted line of FIG. 14) by fixing the upper case (12) to said lower case (20)

The lower case (20) has a hole (18) for transmitting inner heat of upper case (12) to the outside and a space called as female-concaves (17, 19), which are placed in either side of said thermal-transit paths respectively. It is characterized in that said female-concaves' (17, 19) section has trapezoid-shape and one side of the female-concaves has open state and the other side has close state and the risen part (14, 15) of said upper case (12) is inserted firmly in order to prevent from separating and the upper face of said female-concaves (17, 19) has open state and the lower face has close state.

And, in the one side of heat-radiation hole (18) of the lower case (20) female-rack (22) having a combining groove (23), which has predetermined size and depth is equipped. Said female-rack (22) is connected to the lower case by a contact portion (21), which has predetermined radius of curvature for the female-rack's easy bending when predetermined force is given to the female-rack in the upper direction.

It is characterized in that said groove (23) has structure to catch an inner risen part of a male-rack (13) formed on the one side of the upper case (12). The method for adhering the upper case (12) including a wireless transmission device therein to the lower case (20) is that the risen parts (14, 15) of the upper case (12) is settled to adjust the entrance of female-concaves (17, 19) of said lower case (20) and then the risen parts (14, 15) are pushed in the direction from front-open side to the opposite-closed side and then the risen parts (14, 15) adhere to said concaves (17, 19) according to guidance of the groove of the concaves. Separating said upper case (12) from the lower case (20) could be achieved by performing the above process reversely. That is, if we give force to the female-rack (22) in order to get out the groove (23) from the male-rack (13) and then push in the forward direction from rear side and separate the upper case (12), and the upper case (12) would be separated from the lower case (20).

Because a transmitter is placed in a case having the above structure, the transmitter can be adhered stably to a wheel and operate normally during high speed driving. Especially because the lower case adheres to the wheel by a very strong both-sided adhesive agent, the upper and the lower case have less possibility for separating from the wheel.

And, after loading a wireless transmitter, in order to increase thermal conductivity toward outside of a tire it is desirable that the lower case (20) comprises a thermal-transit path (18) for transmitting inner heat of the case to the surface of a wheel easily.

Besides, in order not to transmit the tire's inner heat to a wireless transmitter (11) placed in said upper case (12) it is desirable that the case made of plastic, which has low thermal conductivity.

### 2. A 2nd Preferred Embodiment

The present invention is characterized in that for a casing device for installing a direct-type Tire Pressure Monitoring System (TPMS) wireless transmitter in a wheel, said case is classified into a male-case and a female-case and said male-case slips and goes into a space formed in the female-case by a sliding method and finally it is characterized in that the male-case is caught by the female-case. The other parts, which are not described here, are the same to the 1st preferred embodiment.

### 3. A 3rd Preferred embodiment

The present invention is characterized in that for a casing device for installing a direct-type Tire Pressure Monitoring System (TPMS) wireless transmitter in a wheel, said case comprises a thermal-transit path for transmitting inner heat of the case to the surface of a wheel easily. The other parts, which are not described here, are the same to the 1 st preferred embodiment.

### 4. A 4th Preferred Embodiment

The present invention is characterized in that for a casing device for installing a direct-type Tire Pressure Monitoring System (TPMS) wireless transmitter in a wheel, a wireless transmitter adheres to outer surface of a wheel by a very strong both-sided adhesive agent and is installed in a tire as well as is loaded in said case. The other parts, which are not described here, are the same to the 1 st preferred embodiment.

The following effects are expected for the above present inventions:

First, the possibility for a case to be separated from a wheel during high speed driving of a car is very low.

Second, because the case is made of plastic, its weight is light and the amount of tire heat transmitted toward a wireless transmitter is minimized.

Third, because the case has a thermal radiating hole, it is easy to transmit the heat to the surface of a wheel.

Fourth, it is easy to assemble and disassemble the upper and the lower cases.

Fifth, a wireless transmitter for the present invention can be installed without changing the existing tires and wheels.

Sixth, because the upper case is inserted into and combines with the lower case by a sliding method, the upper and the lower cases adhere to the wheel with firm adhesion to each other.

Seventh, because it is easy to assemble and disassemble the upper and the lower case, if only a battery for the wireless is changed, the wireless transmitter can be used semi-permanently.

Eighth, in changing tires it is needless to purchase a new wireless transmitter and the existing wireless transmitter can be installed in a new tire, and therefore, it is economical.

II. A Hybrid Digital RF Data Transmission Method, A Monitoring System of Inner State of Tires of an Automobile using the Method and a Method for Operating the System

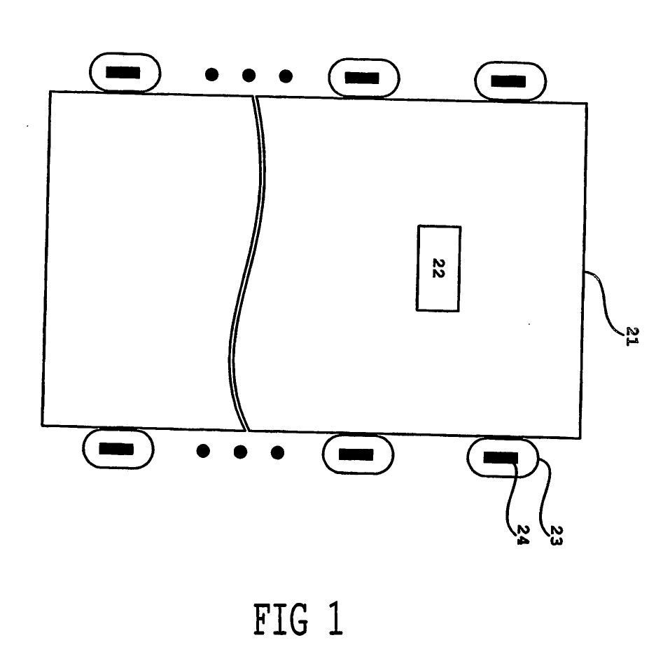

In the present invention, a new RF transmitting/receiving method so called a ‘Megro method’ is disclosed in order to extend the life of the system for monitoring the inner state of a tire of an automobile arranged like the FIG. 1. It is necessary to apply the present invention that a transmitter (24) should be installed in each tire (23) of an automobile (21) and a receiver (22) should be installed in the predetermined position of an automobile like the FIG. 1.

Generally, the amount of battery power consumption for an inner transmitter of a system for monitoring the inner state of a tire of an automobile is equal to the life of the system. Therefore, in this present invention, a predetermined modified CDMA type transmission technology including CS-CDMA (Code Select CDMA) type (hereinafter referred to ‘CDMA’ type) and a TDMA type transmission technology are used together in order to guarantee a system life for a long time (for example, 10 years/240,000 km) and give a transmitter an intelligent ability to control the transmitting interval by putting inner state levels of the tire. This is because the transmitting time increases and then the battery power consumption increases if only the CDMA type is used as a data transmitting technology. In the present invention, by using the CDMA type together with the TDMA type having a short transmitting time. If the result of monitoring the inner state of a tire is normal, then the result is transmitted by using the TDMA type, and if the result of monitoring the inner state of a tire is abnormal, then the result is transmitted by using the CDMA type.

In this present, the above digital RF data transmitting method is called as a hybrid digital RF data transmitting method. This method can be defined like this. That is, the hybrid digital RF data transmitting method is a RF data transmitting method comprising of a step for confirming predetermined data transmitting condition before a transmitter transmits RF data to a receiver, a step for transmitting data by the TDMA type if the predetermined data transmitting condition is satisfied by the confirming step and a step for transmitting data by the CDMA type if the predetermined data transmitting condition is not satisfied by the confirming step.

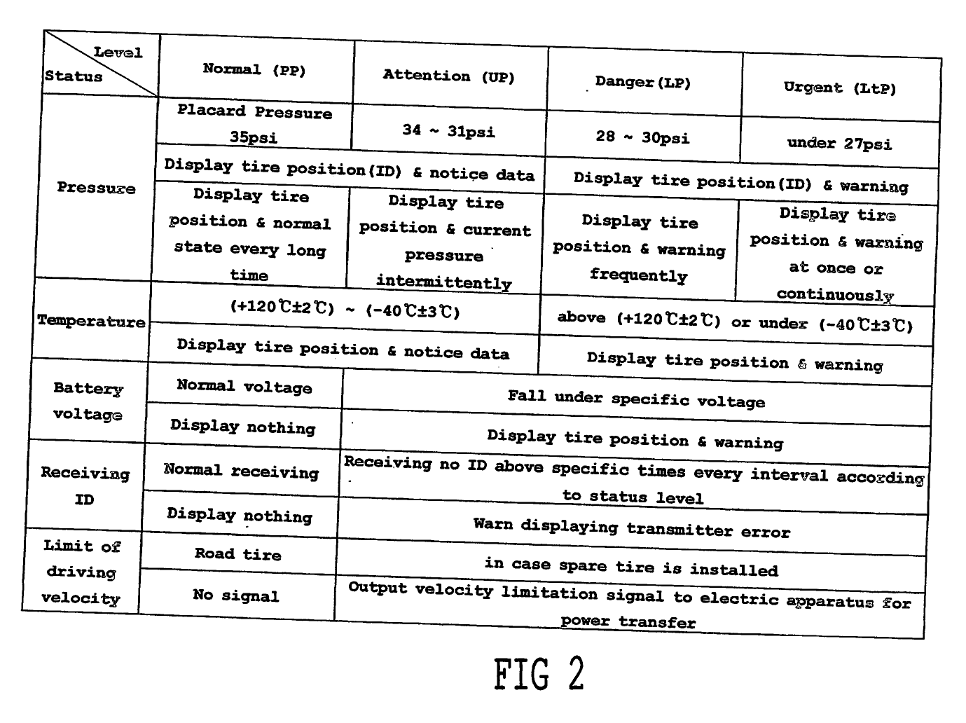

The transmitter according to the present invention has a predetermined intelligence. The meaning of having intelligence is to divide the state level of a road tire and a spare tire into several staged like in the FIG. 2 (for example, 4 stages including an emergency stage, a danger stage, an attention stage and a normal stage) and to monitor them. That is, the decreasing state of pressure is divided into several stages (for example, 4 stages including an emergency stage, a danger stage, an attention stage and a normal stage) with a reference of a tire placard pressure and to monitor the pressure in accordance with the setting range. In case of applying to a standard weight tire of an automobile as an embodiment, the emergency stage is the Lowest Pressure (LtP) (for example, 8 psi lower state than a Placard Pressure (PP) and the same as it, that is under PP-8 psi and the same as it), the emergency stage is the Low Pressure (LP) (for example, 5 psi-7 psi lower state than a Placard Pressure (PP), that is PP-5 psi˜PP-7 psi), the attention stage is the Upper Pressure (UP) (for example, 4 psi lower than a Placard Pressure (PP) and the same as it, that is between PP and PP-4 psi), and less), the normal stage is the Placard Pressure (PP) (for example, PP=35 psi) and takes actions as following in accordance with each state.

In case of LtP, warning data is sent immediately (for-example, 3 seconds interval) or continuously and the tire position (ID) and warning message are displayed.

In case of LP, warning data is sent frequently (for example, 5 seconds interval) and the tire position (ID) and warning message are displayed.

Especially in case of temporary driving with setting of a spare tire/wheel, a signal to limit driving speed (for example, 80 km/h) should be sent to a power train electric apparatus within a predetermined time (for example, 3 minutes).

In case of UP, warning data is sent intermittently (for example, 30 seconds interval) and the tire position (ID) and a present tire pressure are displayed.

In case of PP, the battery life is guaranteed by sending shortly necessary data (for example, ID and data for indicating a normal state) every each long time interval (for example, 3 minutes). Also, in the following cases, they are included in the state stages and monitoring and taking action is executed.

First, if the tire pressure decreases up to 25% of the PP or to the minimum driving pressure, the situation is regard as the LtP stage. However this state is applicable to every assembled spare tire/wheel instead of road tire.

Second, if a road tire pressure rapidly decreases during driving (for example, excess 4 psi for 70 seconds), the situation is regarded as the UP stage and warns intermittently within a predetermined time (for example, within 30 seconds) after the time of rapid decreasing. However, parked cars are exception.

Third, if a road tire pressure is high a predetermined value (for example, 6 psi) than the PP, the situation is regard as the attention or the danger stage and informs intermittently the present pressure within a predetermined time (for example, within 3 minutes).

Fourth, the spare tire/wheel loaded in an automobile warns in accordance with the state within more long time (for example, 3 minutes. For example, if the pressure measured at present (Pnow) is between the attention and the normal stage (UP≦Pnow≦PP) then only a tire position (ID) and an alarm data are displayed, if the pressure measured at present (Pnow) is less than the attention stage (Pnow≦UP) then only a tire position (ID) and a warning message are displayed. As a result, in case of the pressure measured at present (Pnow) is under a predetermined % (for example, 25%) than the PP, then an warning message should be informed in any form and in any method.

Furthermore, if the pressure of the road tire reduces under the danger stage, a warning message is informed to a driver within a predetermined time (for example, 5 seconds). And in case of spare tire, the warning message is informed to a driver within more long predetermined time (for example, 3 minutes).

Also, if the decreased amount of pressure of the road tire for a predetermined time interval (for example, 70 seconds) exceeds a predetermined psi (for example, 4 psi), a warning (for example, an light emitting, LCD, buzzer and voice warning etc.) should be informed within a predetermined time (for example 30 seconds).

And the monitoring system for the inner state of tires is necessary to display the present inner state of the tires (pressure, temperature, battery power etc.) on a displaying device in the form of numbers or characters within a predetermined time (for example, 5 seconds) just after initializing the system. At this time, it is possible to extend the battery lifetime by checking the inner state of tires and by transmitting data by the TDMA type if the checking result is normal, and by transmitting data by the CDMA type if the checking result is abnormal.

And, in an emergency state of tire pressure in driving state, a function for sending speed limit data to a power-train electrical apparatus in order to limit driving speed of an automobile. Furthermore, in a state of a temporary installing spare tire/wheel, the monitoring system of the inner state of tires should send data to the power-train electrical apparatus in order to limit driving speed of the automobile.

The above example corresponds to a case of a pressure, and the dividing the state of road tires and spare tires into several stages (for example, emergency, danger, attention, normal) and the giving of intelligence are applicable to any type of variables indicating the state of tires not only the pressure but also a temperature, a battery electric power and the degree of acceleration.

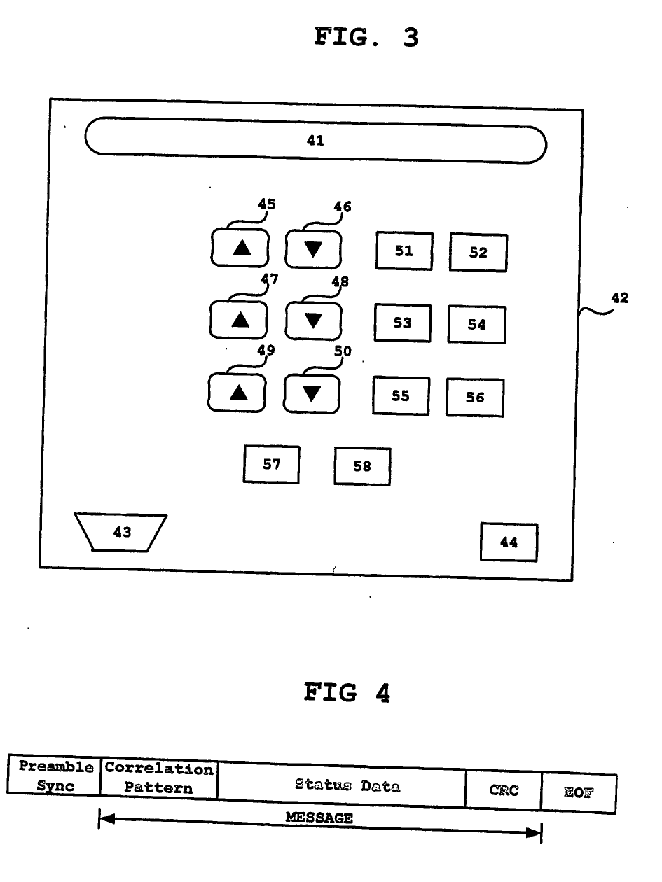

The FIG. 3 indicates an exterior view of an apparatus for inputting and receiving of a tire identifying information according to the present invention. In the present invention, there are ID detectors allocated by software to each tire and counters set to the each detector by software in order to receive the ID signals normally at every a predetermined period (for example, the normal level is 3 minutes). And if the ID signal is not detected over a predetermined times (for example, 4 times) with the period within a predetermined time (for example, 20 minutes), it is judged to have a problem (for example, a battery is totally exhausted or discharged) in an appropriate tire and generates warning signals.

In the present invention, numbers of essential ID are allocated to each tire of an automobile. At this time, it is possible to apply to not only 4-tires automobile but also vehicles having tires over 4 (for example, a bus, a truck and a trailer etc.). That is, it is possible to allocate the essential ID to not only 4-tires automobile but also a trailer added to a truck. At this time, if a tire identifying information inputting apparatus (42) is used, it is possible to identify ID of each tire among a number of automobiles and to closely allocate every ID to almost every number of tires existing in the world (for example, number of 2 raised 64th power). That is, a set of tires can be made by installing a transmitter randomly sampled to the inside a wheel of a tire, by preparing two bar codes having identical ID in the installing stage and by attaching one of two to the transmitter and the other to the exterior of a tire. As an assembled tire to one set cannot be known to be installed to which automobile and to which position of a tire (left, right, top and bottom etc.), the reason of this is to identify all tires in an automobile after installing tires and registering essential ID and the position of the transmitter installed in the installed tire to a receiver. Therefore, bar code ID external to all tires installed in an automobile is read in turn with a predetermined direction (for example, from left₁ to left_{N} or from right₁ to right_{N}) and registered to a receiver after by using any bar code inputting machine sold at a market and by connecting the bar code inputting machine to a bar code inputting port (43, for example, RS-232C port, COM port etc.) of a receiving apparatus case (42) according to the present invention to have a same structure to the FIG. 3 in the installing the installed tires to an automobile stage.

At the time of registration, whenever the external bar code attached to each tire is read by the bar code inputting machine, a bar code contents in the readable form by people (for example, in the form of number etc.) is displayed on a display device (41), and registration is executed by pushing registration buttons (51, 53) and repeating the registration process. If a special case is met (for example, tire puncture, changing a tire and changing a wheel etc.) after the registration and then a process of deletion, re-registration or addition (for example, installing a trailer) of the ID should be executed, it is executed by using left-right buttons (45, 46, 47, 48), registration buttons (51, 53) and deleting buttons (52, 54).

For example, in case of tire puncture, the ID of flattened tire (self ID) to be changed can be found on the display device (41) by pushing the left-right buttons (45, 46, 47, 48). If the ID is found on the display device (41), then people push a change button (57) one time. And then, the ID is flickered on the display device (41) and people can find a change object ID by pushing a spare top-down buttons (49, 50). After finding the change object ID, the re-registration is executed by changing self ID to the change object ID by confirming the ID on the display device (41) and pushing the change object button (58).

In case of changing management ID's position for an automobile, the changing time (for example, year-month-day-time) and all contents of ID are certainly recorded in a memory. To do this, a timer of a receiver monitors the time. The contents recorded in the memory can be transferred to a PC via an external inputting port of the receiver (RS-232C, USB etc.) and it is possible to manage the ID integrated by transferring to an ID management operation server via a telecommunication network (for example, the Internet).

In normal state people do not push the button in a receiver and a data indicating state of a tire in driving state (pressure, temperature and battery etc.) can be displayed. For an automobile having registered ID of a tire, a registered ID is managed through a group ID. Therefore, every automobile will have its group ID managed by itself (4-wheels automobile as an example, 5 ID can be a group including the spare tire). The above method is merely an embodiment and each switch and their function can be re-organized or re-constructed in accordance with user's convenience.

The above example that is an embodiment of a button type can be modified to other types (for example, a touch type and a menu type etc.).

A transmitting frame structure according to the present invention is shown in the FIG. 4. The frame comprises a Preamble Sync, correlation pattern, data information (ID, temperature, pressure, battery state, etc.), CRC, EOF (End of Frame) and etc. In receiving data according to the present invention, it is recognized as the CDMA type if the correlation value is presented and otherwise it is recognized as the TDMA type. An inner structure of data frame (packet) and the arrangement order according to the present invention can be modified to any types in order to get a harmonized purpose of telecommunication.

On the other hand, in the present invention, data is transmitted to a receiver by using a hybrid type data transmission method combining a TDMA type and a CDMA type in accordance with state levels judged intelligently by a transmitter and this is an unique data transmission method of the present invention. That is, it is a transmission method adopting the TDMA type in normal level to reduce transmitting time and adopting the CDMA type in abnormal level to prevent from wrong operation even though the transmitting time is long. In the present invention, this method is called as a hybrid type data transmission method.

In the hybrid type data transmission method, although warning data caused by a transmission error are inputted by the TDMA type, a receiver ignores this error data because this is not a receiving data by the CDMA type. In other words, in abnormal level, the CDMA type transmits data because the transmitter knows the inner state of a tire is abnormal. And in abnormal level, outputs all data necessary to warning and informs a driver emergency state rapidly and correctly by doing not save battery and extending sufficiently transmission time (for example, more than 100 msec). As a result, a battery problem and a wrong operation problem can be solved simultaneously by the hybrid type data transmission method.

In the present-invention, the classification between the TDMA and CDMA types is determined by the existence of a correlation value. That is, it is recognized as the CDMA if there is a correlation value or as the TDMA if there is no correlation value after getting a correlation result by using all used orthogonal codes.

In the present invention, data is received by combining the TDMA and CDMA and a TDMA receiving result is outputted if there is no correlation value or a CDMA receiving result is outputted if there is a correlation value.

In the CDMA type according to the present invention, the length of a correlator (for example, 64 chips, 128 chips) is determined in accordance with the length of orthogonal code. That is, a number of correlators are necessary to distinguish the transmitted data. For example, if the length of a correlator is 128 bits, then multiple of 128 bits correlators transmitting a orthogonal code per 128 bits are used in order to reduce the error operation ate range (for example, error operation rate of 10E⁻⁸). In the present invention, data is transmitted by using a simple and a stable TDMA type n case of normal level and error generation during the transmission is detected by using CRC symbols. In case of error generation, all received data are deleted. And the determination of whether the transmission data is effective or not is executed by interpretation of ID inherently allowed to each transmitter. So, in case of receiving ID not managed by a receiver, the received data is unconditionally discarded. That is, the received data is discarded if the ID is not involved in itself.

In the present invention, if an emergency state of a spare tire (low tire pressure) is generated, a warning signal (for example, light, buzzer, voice, etc.) is outputted within a predetermined time (for example, 3 minutes).

And the present invention uses a motion switch as a method for reducing power consumption of battery. This motion switch isolates a transmitter's power to save battery when an automobile is parked/stopped or driven with under predetermined speed (for example, 20 km) and supplies power to a transmitter only when an automobile is driven with over predetermined speed. Therefore, in normal level at this case, the inner state of a tire is applied and data transmission is executed only when the transmitter operates by power supplied by the motion switch. At this time, the mode is a ‘supplying mode’ if the transmitter is operating by the motion switch or the mode is an ‘isolating mode’ if the transmitter is not operating.

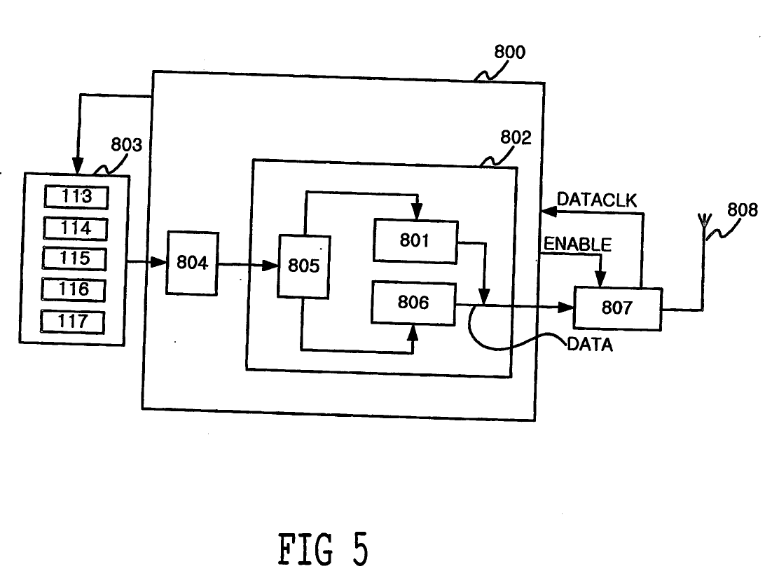

FIG. 5 shows an embodiment of structure of a transmitter according to the present invention. The operating principle of the transmitter shown in the FIG. 5 is as follows. The transmitter comprises a micro-controller (MCU) (800), a sensing part for monitoring the inner state of a tire (803), a TDMA type RF module (for example, OOK, On/Off Keying modulator) (807) and an antenna (808), and the sensing part for monitoring the inner state of a tire (803) comprises a battery electric power sensing part (113), a motion switch (114), a tire pressure sensor (115), a temperature sensor (116) and a battery (117). The micro-controller (800) is composed of a buffer (804) and an internal Flash (802), and the internal Flash (802) comprises a level discriminating part for the inner state of a tire (805), a TDMA modulator (806) and a CDMA modulator (801). At this time, it is characterized in that the discriminating part (805) and modulators (801, 806) in the internal Flash (802) are realized by software.

The transmitter is operated only by the motion switch (114) in the sensing part for monitoring the inner state of a tire (803), and a state level is determined by the discriminating part (805) if a tire inner state data is inputted to a buffer (804) of each MCU (800) (pressure, temperature, etc.), and then go to the TDMA modulator (806) in normal level or go to the CDMA modulator (801) and to a TDMA type non-linear RF module (for example, OOK type carrier wave modulator 807) in abnormal level and then to be outputted via an antenna (808) after being a CDMA/OOK signal.

An example using the ASK (OOK) type modulation technique is as follows. If power is supplied to a OOK(On/Off Keying) carrier wave modulator and the modulator is enabled, a data clock is a reference frequency for data clocking to be supplied to the MCU, and this frequency is a value (for example, 212 KHz) divided into 64 parts of low frequency crystal oscillator frequency (13.56 MHz).

The OOK carrier wave modulator is tuned by a PLL (that is in a TDMA type RF module), and a preparation of transmitting first data inputted from the MCU is finished when an output frequency is moved to desirable frequency by operation of the PLL and is locked not to move.

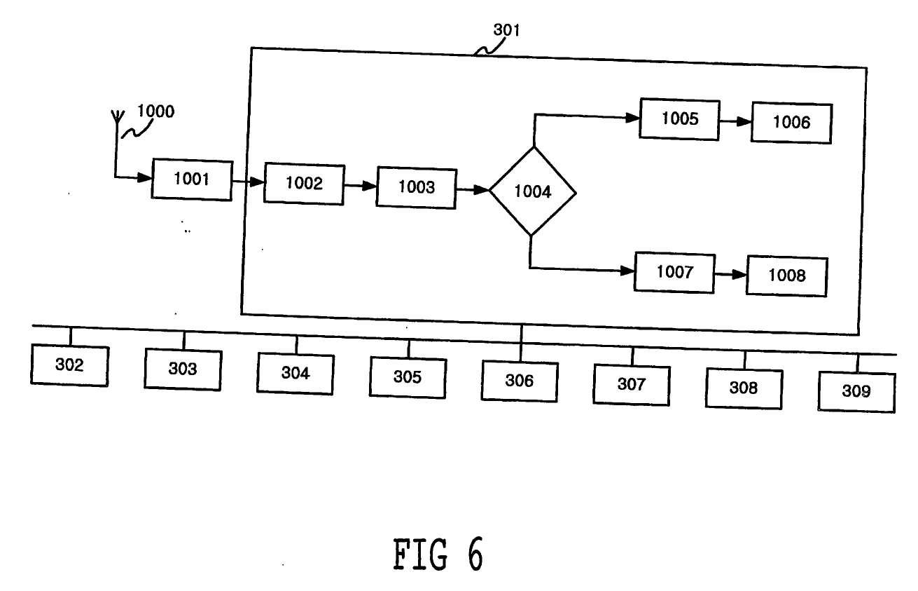

FIG. 6 shows an embodiment of the structure of a receiver according to the present invention. The receiver is comprised by a micro-controller (301), a display (302), a timer chip (303), a non-volatile memory (304), a bar code inputting part (305), a power inputting part (306), a control button part (307), a warning means (308), a data output part (309), a TDMA type RF modulator (1001) and an antenna (1000). The micro-controller (301) comprises a synchronizing part (1002), a correlatior (1003), a correlating value existing discriminator (1004), a TDMA demodulator (1005), a normal level data processor (1006), a CDMA demodulator (1007) and an abnormal level data processor (1008).

As the receiver according to the present invention uses a correlation type, an additional synchronization is not necessary. In other words, the correlation itself means the synchronization. Therefore, an additional time for synchronization is not necessary. But, several bits (for example, 4 bits) pattern for synchronization (for example, 1 0 1 0) is added in order to improve efficiency. And the receiver has a number of correlators (for example, 128) to discriminate data. The process of data receiving and processing is as follows. Data received by the antenna (1000) and the TDMA type RF module (for example, OOK modulator) (1001) is synchronized to orthogonal codes at the synchronizing part (1002), and a correlation value between the received signals and orthogonal codes is calculated by the correlator (1003), and data detected by the TDMA type modulator (1005) is sent to the normal level data processor (1006) if it is determined by using the correlation value existing discriminator (1004) that there is no correlation value or the data detected by the CDMA type modulator (1007) is treated to abnormal level if there is a correlation value.

That is, the data used for selecting the orthogonal code is restored by using the number of the orthogonal codes having a maximum absolute value of the correlation value, and the data used for modulating the orthogonal codes is restored by using the sign of the correlation value, and the data used for modulating the orthogonal code is modulated by using the sign of the correlation value, and the restored or modulated data is sent to the abnormal level data processor (1008) and is treated.

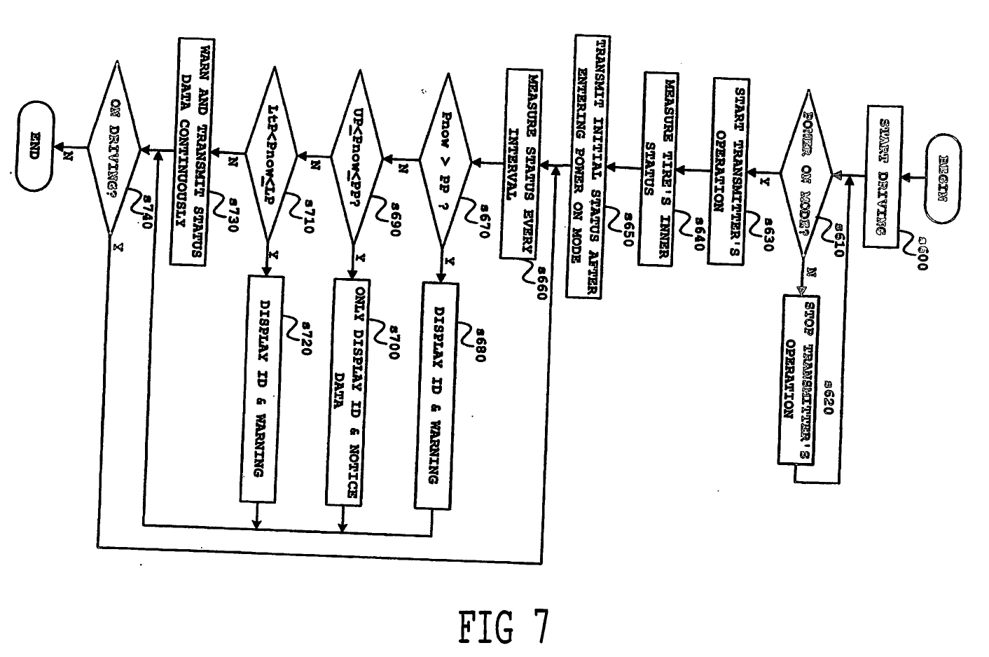

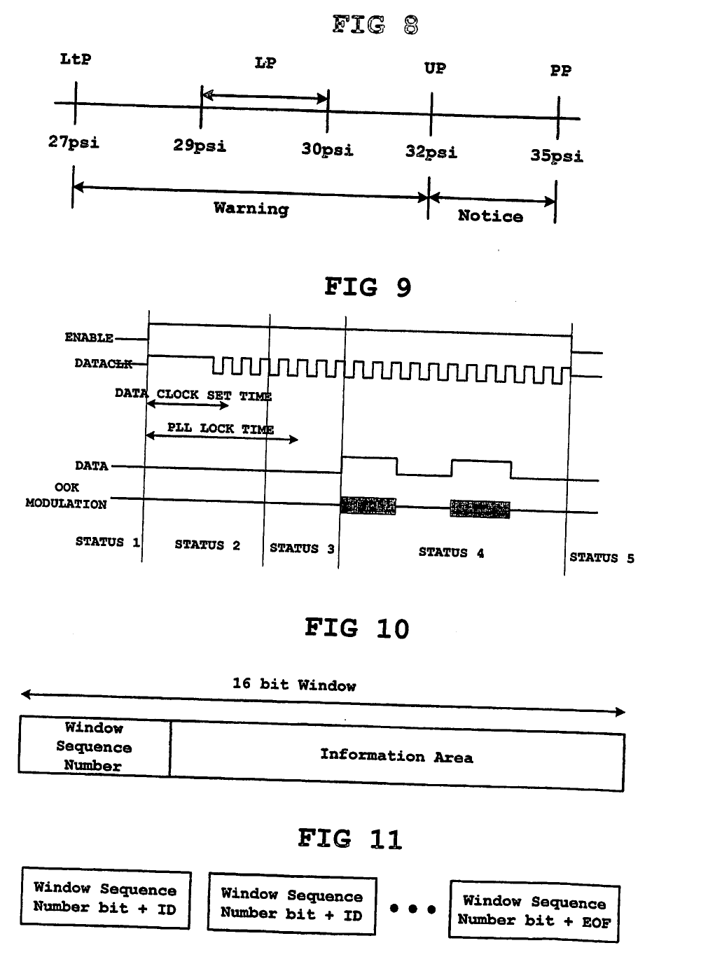

FIG. 7 shows a flow chart of the method for operating the monitoring system of the inner state of tires of an automobile according to the present invention, and the FIG. 8 shows an intelligent processing state of the transmitter and the receiver in accordance with state levels in the present invention and this is a reference for judging the flow chart. With referring to these figures, the operational principle is as follows. At first, as an automobile starts to drive (s600), it is determined whether it is a supplying mode or not (s610). After the determination, if it is an isolating mode, then the operation of the transmitter stops (s620).

When the transmitter starts the operation, checks the inner state of tires (s640) and outputs an initial data since entering to the supplying mode (s650). After this, checks the tire's state in every time interval (s660).

Check the present tire state whether it is an abnormal level or not (s670). That is, check whether Pnow>PP or not. As a result of the checking, if the Pnow is larger than the PP (that is, the pressure is larger than 35 psi), it is judged to be in the danger level (LP), displays the tire position (ID) and warns in every 10 seconds (s680), and checks whether the automobile is still being driven (s740), and then repeats again the state checking step (s660) if the automobile is still being driven or terminates the process if the automobile is stop.

But, if Pnow≦PP, then going to the next checking step. That is, checking whether UP≦Pnow≦PP or not (s690). As a result of the checking, if the pressure is in the range, it determines to be in the normal level and attention level, and displays ID (tire position) and warning data (s700), and checks whether the automobile is still being driven (s740), and then repeats again the state checking step (s660) if the automobile is still being driven or terminates the process if the automobile is stop.

But, if a pressure is not a normal level or an attention level after the checking, go to the next checking step and then check the tire state is in a danger level or not. That is, check whether LtP≦Pnow≦LP or not (s710). As a result of the checking, if a pressure is in the range, determine to the danger level, and display ID (tire position) and warning data (s720), and check whether the automobile is still driving (s740), and then repeat again the state checking step (s660) if the automobile is still driving or terminates the process if the automobile stops.

As a result of the checking, if a pressure denotes an emergency level, that is in the range of Pnow≦LtP, it displays ID (tire position) and warning data (s720), and transmits continuously the state data (s730), and checks whether the automobile is still being driven (s740), and then repeats again the state checking step (s660) if the automobile is still being driven or terminates the process if the automobile stops.

To explain concretely, in normal level, only the ID (tire position) with a long time term (for example, 3 minutes) is outputted in order to express the normal state, in a range between under the normal level (PP) and the attention level (UP), and simultaneously the ID (tire position) and warning data are outputted intermittently (for example, 30 seconds), in a range between under the attention level (UP) and the emergency level (LtP), and the ID (tire position) and warning data are outputted frequently (for example, 10 seconds), under the emergency level (LtP), and the ID (tire position) and warning data are outputted continuously (for example, 3 seconds).

In the monitoring system of the inner state of tires according to the present invention, a transmitter uses a low-cost, low-power operation, high-performance low bit (for example, 8 bits or 16 bits RISC core) MCU (Micro-controller Unit) to make the battery consumption to minimize and to guarantee the system lifetime. The inner structure of the MCU has thousands of bytes (for example, 4 Kbytes) on-chip FLASH memory, hundreds of bytes (for example, 128 bytes) on-chip RAM memory, hundreds of bytes EEPROM and supplementary machines. In the FLASH memory, as a TDMA modulator (806) and a CDMA modulator (801) are made to have simple structure and are operated by software, the structure of the transmitter can be simple and then the price can be lowered.

As the RF data transmission method used in the present invention possesses a performance of usual CDMA and the transmission signal's waveform is equal to the TDMA type, the TDMA RF amplifier that is produced on a commercial state and is a stable can be used without any modification, and then it is sufficient to have a competitive performance and price.

As the CDMA type in the present invention modulates and outputs only one orthogonal code, the waveform of the modulated signal is maintained to Binary form nevertheless using of multi-code, a linearity of an RF amplifier (AMP) is not necessary, the modulation is possible only with the binary signal processing in a receiver, the structure of the system can be simple.

And, as the CDMA type in the present invention allocates orthogonal codes to each lock instead of allocating an orthogonal code to a data channel one by one and selects the orthogonal code by using a transmission data value, there is no damage of orthogonal caused by a truncation compare to a PW-CDMA type in case of one code select block and the efficiency of modulation at the end of the receiver can be improved.

FIG. 9 is a timing diagram showing that the transmission data is loaded on a carrier wave and is modulated by OOK type. The data received from the MCU are outputted through the process of states 1, 2, 3 and 4. At this time, a modulator is a ready state with small consumption current in the state 1, a PLL operates but is not locked in the state 2, the PLL is locked and is waiting the first data in the state 3, the data is loaded on a carrier wave, is modulating in TDMA RF type (for example, OOK type) and is outputted in the state 4.

FIG. 10 shows a frame structure of multiple number bits window. That is, a 16 bits window largely consists of a window order number and information area (kinds of the inner state of tires and a transmission bit accordance with the level). A transmission frame is divided into windows with a unit of number bits (for example, 8 bits or 16 bits) and is transmitted in the form of burst, and by receiving many windows (for example, 4) and assembling it in good order, a complete frame is formed. Each window selects one orthogonal code from CS clock comprising predetermined numbers (for example, 8) of orthogonal code by using a number of bits (for example, 3 bits) and repeats the process for selecting one orthogonal code from CS clock comprising another predetermined numbers (for example, 8) of orthogonal code by using another a number of bits (for example, 3 bits) with predetermined times, loads data after logically multiplying an information bit to each selected orthogonal code.

For example, as only a tire position (ID) is transmitted in case of normal pressure, the length of 64 bits ID is divided into 16 bits by 16 bits Window, is transmitted and is assembled at the end of the receiver. At this time, there is an EOF (4 bits) in a last received Window and it is possible to know that the pressure is normal from the 4 bits information. FIG. 11 shows the structure of transmission frame in a normal pressure state.

In the present invention, the preamble is a part necessary for synchronization of the system. And as the transmission waveform of the CDMA type according to the present invention is identical to the TDMA type, it is possible to make the system structure simple and to have more superior synchronizing characteristics by the synchronization done by the preamble type like in the TDMA type compare to the case of using separate synchronized channel like in the CDMA type. The CDMA or TDMA information can be transmitted by a message part. And an EOF (End of Frame) is used to protect the message at the end of the transmission frame with the same manner to the TDMA type.

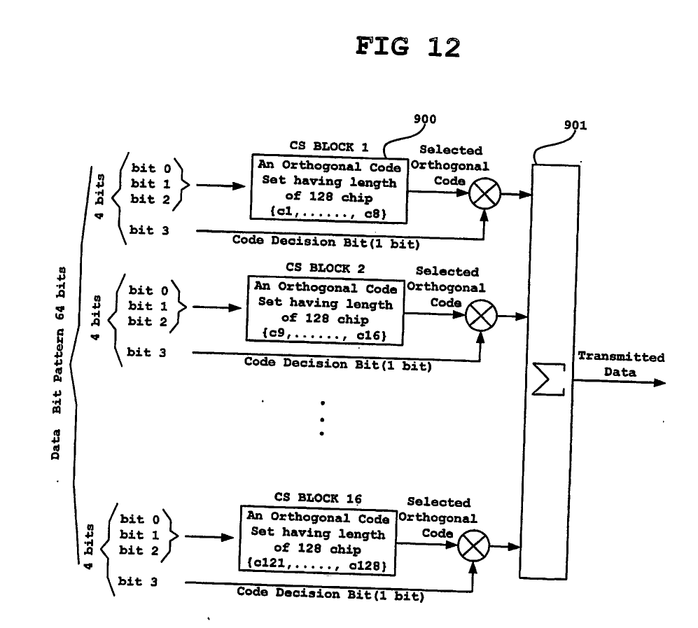

FIG. 12 shows an embodiment of the structure of CDMA modulator in the FIG. 5. First of all, the problem of traditional code selection CDMA technology using multiple code selection blocks (900) is as follows. Generally, in the code selection CDMA modulator, it is suitable to set the number of the orthogonal code in a CS block to 8 even though it does not matter to select 8 or 16. The reason of choosing the number of the orthogonal code in a CS block to 8 is that 4 bits are transmitted by an orthogonal code. On the other hand, if the number 16 as the orthogonal code in a CS block is chosen, as only 5 bits per one orthogonal code are transmitted and then the efficiency of orthogonal code will be lowered.

Therefore, the most reasonable number of orthogonal codes to allocate to one CS block is 8. That is, allocating 8 orthogonal codes to one CS block is the best for an efficiency of orthogonal code. In a CDMA modulator having 8 orthogonal codes with 128 bit length in a CS block, as an example of transmitting of data bit pattern in this condition, totally 16 bits are received by transmitting data bit pattern 4 bits for 4 times. As a more detailed example, the explanation of a CDMA modulator having 128 orthogonal codes is as follows.

First of all, a modulating orthogonal set is generated in a length of 128 chips (or 64 chips) in order to maintain orthogonal characteristics between transmitted information channels, and the generated total (for example, 128) orthogonal code set (for example, {c121, . . . , c128}) is divided into a number of code select blocks (for example, more than two). For example, the orthogonal code set is combined in a unit of 2 to the power of 3 (that is, 8) (For example, 16 blocks like {c1-c9}, {c9-c16}, . . . , {c121, . . . , c128}). Next, independently data bit pattern to be transmitted (digital bit value) is allocated to each code selection block (CS block).

For an example, if allocation is made per 4 bits, total 128 orthogonal codes are divided into total 16 CS blocks (900), and each CS block (900) has 3 bits of data pattern (4 bits) allocated to the CS block, and one orthogonal code of numbers of 2 to the power of 3 orthogonal codes is selected, and then 4 bits data bit pattern is diffused by multiplying it by one another bit.

Next, a carrier modulation is executed after adding the bits diffused in each CS block unit and transmitting. At this time, in the CDMA transmission consisting of only one basic CS block, as only one orthogonal code is selected even though the input data bit pattern consisting of bits and basically there is no a Level Clipping in a CS block unit, an efficiency down by the level clipping can be protected. But, many basic CS blocks (900) are used to relieve problem generation by increasing bit number (channel number) and by exponentially increasing the size of a code set. In case of using simultaneously numbers of CS block (900), as the outputs diffused in each CS block unit are summed in a digital adder (901) and is transmitted, it is a multi level signal having a large change of signal size. To transmit this multi-level signal after modifying to the form of a constant envelope, the CDMA type truncates the multi level signal, restricts the signal size to a constant level, and then executes a carrier modification. In this way, as there is a damage of orthogonal characteristics of the orthogonal code by the truncation.

Therefore, the present invention use a multi block to overcome the problems of the traditional CDMA type and maintain a constant envelope by transforming the signal size to binary without truncation and selects appropriate code by using the expanded formula using a Hadamard matrix in an encoding process for encoding the inputted data bit pattern.

As a result, the existing DS-CDMA type requires a linear RF amplifier, on the other hand, it is possible to use a cheap and good efficient commercialized non-linear RF amplifier in the present invention, and it is also possible to realize to economical and simple structure and to overcome a fading by high speed moving without problem of interference between tires (RF transmitter).

This invention can be modified into various forms. Although only specific embodiments are shown in the detailed description of this invention, it is obvious to be understood this invention is not confined to the embodiments and includes all modifications and replacements within the scopes and sprits of this invention defined by the claims.

And the advantages according to the present invention are expected as follows.

First, there is no data transmission error by an external interference. Especially, as it is strong against interference between transmitters, there is no data transmission error even when a rate of the transmission error is bad to the extent of 10E⁻¹.

Second, the data transmitting from tires is not broken even though they are close to each other.

Third, the data recovery is possible even though error is generated during the data transmission.

Fourth, it is very strong against an external noise and an interference signal.

Fifth, it is very strong against a multi-path.

Sixth, it has a completely separating characteristic between channels.

Seventh, it is possible to maintain an amplifying character having a good linearity even though a linear amplifier is not used.

Eighth, an amplifying efficiency of an amplifier is good and the usable time of a battery is long.

Ninth, the embodiment of system structure is simple even in case of using a multi-channel.

Tenth, it is possible to modulate signal with only a binary signal processing, to make the system structure simple and to make the system with cheap price.

Eleventh, it is possible to maintain low error rate, as the good efficiency of the system is strong against all surrounding noise signals or interference wave.

Twelfth, it is possible to guarantee the system lifetime and is strong against interference between transmitters.

Thirteenth, there is no problem of supplying of the parts.

What is claimed is:

1. A casing device of a transmitter for a Tire Pressure Monitoring System (TPMS) of an automobile, said device for installing a direct-type TPMS wireless transmitter in a wheel, wherein said device comprises a lower case and an upper case, and said lower case adheres to the outer surface of said wheel by a strong both-sided adhesive agent and has the same curved surface as said wheel and said upper case combines with said lower case and adheres to said lower case.

2. A casing device of a transmitter for a TPMS of an automobile as set forth in claim 1, wherein said lower case comprises:
a thermal-transmission path transmitting inner heat of said upper case to the surface of said wheel rapidly;
a pair of female-concave which is a space having a trapezoid-shape section placed in either side of said thermal-transmission path respectively,
a female-rack placed in another side of said thermal-transmission path,
a combining groove which has predetermined size and depth, formed in a predetermined place of said female-rack; and
contact portion which has predetermined radius of curvature for said female-rack's easy bending when force is applied to said female-rack in the upper direction, placed in a connecting part between said female-rack and said lower case.

3. A casing device of a transmitter for a TPMS of an automobile as set forth in claim 2, wherein said upper case comprises:
a male-rack placed on one surface of said upper case and having a risen part of “ [symbol] ” shape in the inner of said upper case;
male-risen parts placed in both of left and right side of said lower part of said upper case and having a section of trapezoid shape and a size corresponding with said female-concave; and
a space formed between said male-risen parts

4. A casing device of a transmitter for a TPMS of an automobile as set forth in claim 3, wherein said female-concaves' section has trapezoid-shape, one side of said female-concaves has open state and the other side has close state in order to prevent said male-risen parts adhered firmly to said upper case from separation and said upper face of said female-concaves has open state and the lower face has close state.

5. A casing device of a transmitter for a TPMS of an automobile as set forth in claim 4, wherein in order to adhere said upper case including a wireless transmission device to said lower case, said male-risen parts of said upper case is settled to adjust the entrance of said female-concaves of said lower case and then said male-risen part is pushed according to the guidance of said groove of said female-concaves in the direction from front-open side of said female-concaves to the opposite-closed side for firm adherence and then said female-rack is bent toward the upper direction until said combining groove is caught by said male-rack and in order to separate said upper case from said lower case, force is given to said female-rack for getting out said combining groove from said male-rack and then said upper case is pushed in the direction of forward from rear side to separate from said upper case.

6. A casing device of a transmitter for a TPMS of an automobile as set forth in claim 1, wherein said upper and lower case are made of plastic having low thermal conductivity, in order not to transmit said tire's inner heat to a wireless transmitter placed in said upper case.

7. A casing device of a transmitter for a TPMS of an automobile as set forth in claim 1, wherein in order to insert said wireless transmitter into said upper case, into a PCB guide which guides PCBs for said wireless transmitter said PCB is inserted and pushed and then said PCB is adhered to said guide firmly.

8. A casing device of a transmitter for a Tire Pressure Monitoring System of an automobile, said casing device for installing a direct-type TPMS wireless transmitter in a wheel, wherein said case is separated into a male-case and a female-case and said male-case slips and goes into a space formed in said female-case by sliding method and finally said male-case is locked to said female-case.

9. A casing device of a transmitter for a Tire Pressure Monitoring System of an automobile, said device for installing a direct-type TPMS wireless transmitter in a wheel, comprising a thermal-transmission path located at a predetermined position of said case for transmitting inner heat of said case to the surface of said wheel easily.

10. A casing device of a transmitter for a Tire Pressure Monitoring System of an automobile, said casing device for installing a direct-type TPMS wireless transmitter in a wheel, comprising a wireless transmitter which adheres to outer surface of said wheel by a strong both-sided adhesive agent and is installed in a tire with a loaded state in said case.

11. A hybrid digital RF data transmitting method comprising the steps of:
a step for confirming predetermined data transmitting condition before a transmitter transmits RF data to a receiver;
a step for transmitting data by a TDMA (Time Division Multiple Access) type method if said predetermined data transmitting condition is satisfied by said confirming step; and
a step for transmitting data by a CDMA (Code Division Multiple Access) type method if said predetermined data transmitting condition is not satisfied by said confirming step.

12. A data transmitting method as set forth in claim 11, wherein said CDMA type method includes a CS-CDMA (code select CDMA) type method.

13. A data transmitting method as set forth in claim 11, wherein said predetermined data transmitting condition is that the data of a tire condition monitored by a Tire Pressure Monitoring System of an automobile satisfies a normal state.

14. A hybrid digital RF data transmitting method in order to check the inner state of tires of an automobile and to display warning signal, wherein an RF transmitter having a means for checking the inner state of a tire is attached to each tire and a receiver is attached to a predetermined position of the inside of an automobile in order to inform a driver the inner state of each tire and to display a warning message if necessary, wherein said hybrid digital RF data transmitting method comprising the steps of:
a step for starting the automobile driving;
a first determination step for determining whether said being driven automobile is in a supplying mode or in an isolating mode;
a step for stopping the operation of a transmitter if said being driven automobile is in an isolating mode after said determination;
a step for starting the operation of a transmitter if said being driven automobile is in a supplying mode after said determination;
a first checking step for checking the inner state of a tire after a transmitter begins to operate;
a step for RF transmitting of an initial state data to a receiver after entering said supplying mode;
a second determination step for determining the state of a tire at a constant interval of time;
a second checking step for checking with a basis of said determined state whether the state of a tire is a in a normal/attention state or a in a danger/emergency state in accordance with a specific reference;
a step for displaying a corresponding display information via a displaying device of a receiver in accordance with the result of said second determination; and
a step for checking whether an automobile is being driven or not and then executing said second determination step if said automobile is in a driving state or stopping said second determination step if not in a driving state.

15. A hybrid digital RF data transmitting method as set forth in claim 14, wherein a decreased level of a tire is divided into several stages on the basis of a declared pressure of a tire in order to define the tire state, and an emergency level is classified into the lowest pressure (LtP), a danger level is classified into the low pressure (LP), an attention level is classified into the upper pressure (UP) and a normal level is classified into the placard pressure (PP), and wherein actions to be taken in accordance with said classification comprise the steps of:
in the LtP, displaying a tire position (ID) and a warning massage by transmitting a warning data immediately or continuously;
in the LP, displaying a tire position (ID) and a warning massage by transmitting a warning data frequently;
in a driving state with a temporarily installed spare tire/wheel, supplying a signal for limiting the driving speed within a specific time to a power train;
in the UP, displaying a tire position (ID) and a state of the present pressure by transmitting a warning data intermittently;
in the PP, guaranteeing the lifetime of a battery by transmitting shortly only needed data in every long time interval;
regarding as the emergency level (LtP) if a tire pressure reduces to below 25% of said declared pressure or to the minimum driving pressure, and applying said state to assembled spare tire/wheel substituted for driving tires;
with the exception of parked cars, regarding as attention level (UP) if load tire pressure rapidly reduces in driving, and warning intermittently within a predetermined time just after exceeding the rapid reduction;
regarding as attention or danger level if air pressure of a load tire is higher than the declared pressure (PP) by a specific psi, and informing intermittently the present pressure state within a predetermined time; and
applying a spare tire/wheel installed in an automobile to the state level and then warning within a time being longer than a predetermined time.

16. A hybrid digital RF data transmitting method as set forth in claim 15, wherein said data is transmitted from a transmitter to a receiver by using a hybrid digital RF data transmission method, and said data transmission condition is that said measured pressure of a road tire is at a normal level or not, and said data transmission is executed by a TDMA type if said pressure is at a normal level, and said data transmission is executed by a CDMA type if said pressure is at an abnormal level.

17. A hybrid digital RF data transmitting method as set forth in claim 14, wherein the power of a transmitter is cut off if a driving speed is less than a specific speed.

18. A hybrid digital RF data transmitting method as set forth in claim 15, wherein a receiver transmits a tire position and information data for the PP or UP cases, and said receiver transmits a tire position and warning display data for the LP or LtP cases.

19. A hybrid digital RF data transmitting method as set forth in claim 14, wherein the data transmitted from a transmitter is modulated by a TDMA RF type method in a state loaded on the carrier wave, and the transmission data received from a MCU inside of a transmitter is transmitted through:
a step for preparing operation with small consumption current by a modulator;
a step for waiting locking because PLL is not yet locked although the PLL operates;
a step for waiting a first data after the PLL is locked; and
a step for transmitting data after data are loaded on the carrier signal (carrier wave) and modulated by the TDMA RF type method.

20. A hybrid digital RF data transmitting method as set forth in claim 14, wherein said step for receiving data by a receiver comprises:
a step for receiving data from an antenna and modulating by a TDMA RF modulator;
a step for synchronizing data by a synchronizing part;
a step for checking whether a correlation value is or not by a correlator;
a step for modulating the data by a CDMA type method if there is a correlation value after said checking and treating the data by an abnormal level data processor; and
a step for modulating the data by a TDMA type method if there is not a correlation value after said checking and treating the data by a normal level data processor.

21. A monitoring system of the inner state of tires for an automobile in order to measure the inner state of a driving tire and to display warning in emergency state, wherein said monitoring system comprises:
a number of RF transmitters installed to each tire; and
a receiver for receiving digital RF data for a tire state transmitted in constant time interval and installed in a predetermined place inside of an automobile, and
a transmitter transmitting data to a receiver by using said hybrid digital RF method.

22. A monitoring system as set forth in claim 21, wherein said transmitter comprises:
an antenna;
a battery for supplying direct current electric power;
a discrimination means of the inner state level of a tire for detecting the electric power of said battery, and measuring the temperature of the inner side of a tire, and measuring the, pressure of the inner side of a tire;
a motion switch for cutting off the electric power supplied from said battery to said transmitter in case the automobile is parked or being driven under the speed of a predetermined driving speed, and for supplying the electric power to said transmitter only when the automobile is being driven over the speed of a predetermined driving speed;
a micro-controller for controlling said battery and said each means; and
a TDMA RF modulator for receiving data from said micro-controller and for transmitting said data to said receiver by through said antenna.

23. A monitoring system as set forth in claim 21, wherein said receiver comprises:
a TDMA RF modulator for receiving data transmitted from a number of transmitters through said antenna and for modulating said received data;
a number of correlators for calculating a correlation value of data received from said TDMA RF modulator;
a discriminator for discriminating the existence of said calculated correlation value;
a CDMA modulator for modulating data in case of existing of said correlation value;
a TDMA modulator for modulating data in case of not existing of said correlation value;
a means for treating an abnormal level data modulated by said CDMA modulator;
a means for treating a normal level data modulated by said TDMA modulator;
a data output part for outputting said received data to the outside;
a non-volatile memory for storing a predetermined data;
a bar code inputting part for inputting bar code information of each tire;
a control button part for controlling data received from said transmitter to desirable information;
a means for generating warning in accordance with a predetermined warning condition;
a means for supplying electric power to each part of said receiver;
a timer chip for controlling time;
a display device for displaying the present inner state of a tire including a pressure, a temperature and a battery electric power in the form of number or character within a specific time set by a timer chip; and
a micro-controller for controlling each component of said receiver.

24. A monitoring system as set forth in claim 21, wherein said data frame comprises a Preamble Sync, a correlation pattern, an ID, a temperature, a pressure, a tire state data including said battery, a CRC and an EOF.

25. A monitoring system as set forth in claim 23, wherein connecting a bar code input port of said bar cord input means including a left button, a right button, a registration/deletion button, a spare button, a replacing button, said bar code input port, a data output port and a display device for displaying the information of a tire to a bar code reader, and reading bar cord ID locating outside of all tires installed to an automobile in a predetermined direction and in order, and then registering said read bar code ID to said receiver.

26. A monitoring system as set forth in claim 21, wherein said system displays only ID (tire position) with a long time interval to inform normal state in case of a normal level, and displays simultaneously an ID (tire position) and a warning data intermittently in case of being between the normal level and the attention level (UP), and displays an ID (tire position) and a warning data frequently in case of being between the attention level and the emergency level (LtP), and displays an ID (tire position) and a warning data continuously in case of being under the emergency level (LtP).

27. A monitoring system as set forth in claim 26, wherein said system detects error generated in the transmission by using the CRC sign in normal level, and discards all received error data.

28. A monitoring system as set forth in claim 21, wherein the determination of whether the data received from said receiver is in effect or not is executed by reading ID essentially allocated to each transmitter and ignoring an ID that is not controlled by said receiver.

29. A monitoring system as set forth in claim 21, wherein said transmission frame is divided into predetermined units of windows and transmitted in the form of burst type, and a frame is formed by receiving many windows and assembling them in order, and each window selects one orthogonal code from a CS block consisting of predetermined number of orthogonal codes by using an information bits and repeats said step for selecting one orthogonal code from a CS block consisting of predetermined number of another orthogonal codes by using another information bits to a predetermined time, and loading data by logically multiplying each selected orthogonal code by an information bit.

30. A monitoring system as set forth in claim 21, wherein said receiver further comprises a synchronizing pattern to improve efficiency.

31. A monitoring system as set forth in claim 22, wherein said a first micro controller comprises a buffer and an inner Flash, and said Flash comprises a discrimination means of the inner state level of a tire, a TDMA modulator and a CDMA modulator that are implemented by a software.
